(19) United States
(12) Patent Application Publication
(10) Pub. No.: US 2026/0085197 A1
(43) Pub. Date: Mar. 26, 2026

(54) AQUEOUS DISPERSION BASED ON THERMOPLASTIC POLYMERS

(71) Applicant: SICHEM, Trazegnies (BE)

(72) Inventors: Farid OUHIB, Trazegnies (BE); Christophe LECLERCQ, Trazegnies (BE)

(21) Appl. No.: 19/152,294

(22) PCT Filed: Feb. 1, 2024
(86) PCT No.: PCT/EP2024/052497

§ 371 Date: Jul. 30, 2025

(30) Foreign Application Priority Data
Feb. 3, 2023 (BE) 2023/5084
Jun. 16, 2023 (EP) 23179904.0

(51) Int. Cl. C09D 7/61; A47J 36/02; A47J 36/04; C08K 3/04; C08K 3/30; C08K 3/34; C08K 3/38; C09D 5/16; C09D 7/43; C09D 7/45; C09D 7/80; C09D 127/12; C09D 171/00

(52) U.S. Cl. CPC C09D 7/61; A47J 36/025; A47J 36/04; C09D 5/1618; C09D 5/1668; C09D 7/43; C09D 7/45; C09D 7/80; C09D 127/12; C09D 171/00; C08K 3/042; C08K 2003/3009; C08K 3/346; C08K 2003/385

(57) ABSTRACT

An aqueous composition comprising a thermoplastic polymer, an inorganic thickening and/or stabilizing agent derived from a silicate, and a mineral dispersant, a method for producing said composition, a method for applying same to a substrate, and the substrates coated by this composition.

### TECHNICAL FIELD

This invention relates to an aqueous formulation (composition) based on thermoplastic polymer, such as polyaryletherketones, such as polyetherketone (PEK), polyetheretherketone (PEEK) or polyetherketoneketone (PEKK), stabilised by an inorganic thickening and/or stabilising agent derived from a silicate and a mineral dispersant having a layered structure.

### PRIOR ART

The class of polyaryletherketones is well known and offers interesting properties, such as temperature resistance, resistance to chemical agents, and thermal conduction.

Among these, polyetheretherketone; PEEK) is known for its good performance at high temperatures, very good mechanical strength, and very good chemical resistance. However, the melting temperature of such a molecule is high, increasing the costs and complexity of application processes. Furthermore, having to work at high temperatures risks affecting other components of the formulation.

Therefore, a variety of basic polyaryletherketone molecules have been developed, such as other less crystalline molecules that are either substituted or have an alteration in the aryl ether repeat, which allows for either a simpler application method or a modification of their properties.

Various attempts have been made to formulate these molecules.

WO 2015/065710 describes the mixture of a particulate material, for example kaolinite, and a deformable polymer. These can be placed in an alkaline solution. There is also the description of fillers.

EP3728401 describes a polymer comprising a polyetheretherketone having methylations on the aryl group. Fillers or reinforcing agents may be present. This polymer can be applied by moulding onto metal.

EP3710517 describes the use of a sulfonated aryl ketone as a dispersing agent for an aqueous solution comprising a polyaryletherketone.

WO 2005/23893 describes an aqueous dispersion comprising a polymeric material and an organic surfactant according to a specific chemical structure.

Therefore, to a certain extent, aqueous polyaryletherketone compositions have been produced.

However, the inventors noted that these compositions were either not stable over time or during heat treatment, or were difficult to apply evenly to a surface, such as a vertical surface.

### BRIEF SUMMARY OF THE INVENTION

The object of the invention is to address the aforementioned disadvantages by providing an aqueous composition comprising:
a water-insoluble thermoplastic polymer or a polyaryletherketone,
an inorganic thickening and/or stabilising agent derived from a silicate, and
a mineral dispersant having a layered structure or graphene oxide or boron nitride, optionally functionalised.

Therefore, the invention provides that the water-insoluble thermoplastic polymer, such as PAEK, is dissolved in the presence of the inorganic thickening and/or stabilising agent derived from a silicate and a mineral dispersant having a layered structure.

The composition according to the invention makes it possible to easily coat metal surfaces, either directly or over an internal ceramic layer (e.g., boron nitride and aluminium oxide), lending them, for example, resistance to chemical agents, mechanical strength, and/or impact resistance.

In particular, this approach makes it possible to at least limit, where necessary, or even eliminate the presence of toxic compounds, such as chromium (VI) or additives used in the formulation of Teflon.

Similarly, advantageously, the aqueous formulation developed does not use toxic, corrosive or hazardous products.

The dependent claims refer to other advantageous embodiments.

Preferably, the inorganic thickening and/or stabilising agent derived from a silicate is talc or clay or an aluminosilicate, preferably a phyllosilicate, more preferably a smectite.

Advantageously, the thermoplastic polymer is chosen from the group comprising polyaryletherketone, such as polyetherketone (PEK), polyetheretherketone (PEEK) or polyetherketoneketone (PEKK), polysulfone, polyethersulfone, polyetherimides, polyamide, polyimide, aramid, polyphenylene oxide (PPO), compounds comprising phenoxy groups, modified polyphenylene oxide (modified PPO), polyvinylpyrrolidone (PVP), poly(aryl)sulphide, polystyrene (PS), polycarbonate, polyarylether, polyaryletherketone, polyarylsulphide, polybenzimidazole, polyvinylidene fluoride (PVDF), ethylene tetrafluoroethylene (ETFE), perfluoroalkoxy, fluorinated ethylene-propylene (FEP), polychlorotrifluoroethylene (E-CTFE), ethylene vinyl alcohol (EVOH) and mixtures thereof.

More preferably, the inorganic thickening and/or stabilising agent derived from a silicate is a potassium and/or sodium silicate.

In the context of this invention, the thickening agent may also act as a stabiliser.

The ratio between the maximum surface area of the thickener and the thickness of the inorganic thickener derived from a silicate is advantageously greater than 100.

The aqueous composition according to the invention is preferably a dispersion.

According to a particularly preferred embodiment, the composition comprises at least 30% by weight of water relative to the total weight of the composition.

Advantageously, the composition further comprises at least 10% by weight, preferably at least 30% by weight of a second polymer, preferably chosen from a fluoropolymer, nylon and natural polymers.

Preferably, the composition comprises at least 5% by weight of an additive having a coefficient of friction of less than 0.3, preferably less than 0.2, more preferably less than 0.1 and preferably chosen from the group comprising tungsten sulphide, molybdenum sulphide, boron nitride, tungsten carbide, silicon carbide, inorganic oxides (titanium oxide, silicon oxide, zirconium oxide), and mixtures thereof.

Other embodiments of the composition are included in the set of claims.

This invention also relates to a method for formulating a composition according to the invention, comprising the steps of adding the following elements to an aqueous solution with mechanical stirring:
an inorganic thickener and/or stabiliser being a silicate or a silicate derivative, then
a mineral dispersant or graphene oxide and/or boron nitride,
particles of a water-insoluble thermoplastic polymer or a polyaryletherketone,
   said mechanical stirring preferably being carried out at at least 2000 rpm and/or for at least 1 hour.

The thickener acts as a stabiliser. This characteristic is already present in the thickener described within the scope of this invention.

The invention preferably relates to a method of applying the composition according to the invention, comprising the step of spraying, optionally at room temperature, said composition onto a substrate, then curing the coated substrate, so as to fix a coating thereon, preferably for at least 5 minutes and/or at a temperature above the melting temperature of the thermoplastic polymer, preferably between 17° and 450° C., preferably between 40° and 430° C., such as approximately 420° C.

More advantageously, the substrate is a metal or a ceramic.

According to an advantageous embodiment, the substrate is selected from a metal and a ceramic, covered with a coating comprising a polyaryletherketone.

Other embodiments of the method are described in the set of claims.

This invention also relates to a substrate chosen from a metal and a ceramic, covered with a coating comprising a water-insoluble thermoplastic polymer or a polyaryletherketone, and which can be obtained by the method according to the invention.

Even more preferably, the invention targets a substrate coated as described above, wherein the coating comprises at least 30% by weight of water-insoluble thermoplastic polymer or polyaryletherketone and/or at least 0.01%, preferably at least 1% of a silicate derivative and/or at least 0.01%, preferably at least 0.1% of a mineral dispersant or graphene oxide and/or boron nitride.

Preferably, the substrate comprises either at least 60% by weight of the water-insoluble thermoplastic polymer or polyaryletherketone, or at least 30% by weight of the water-insoluble thermoplastic polymer or polyaryletherketone and at least 30% by weight of another polymer, preferably selected from fluoropolymers, natural fibres and nylon.

The present invention also covers any product comprising the composition according to the invention.

Other embodiments of the product are available in the set of claims.

The invention may also relate to a kitchen utensil comprising a coating comprising a water-insoluble thermoplastic polymer or a polyaryletherketone, a silicate derivative (preferably an aluminosilicate and/or a sodium or potassium silicate) and a mineral dispersant or graphene oxide and/or boron nitride, said water-insoluble thermoplastic polymer or said polyaryletherketone being present in the coating in an amount of at least 30% by weight.

Advantageously, the coating further comprises a fluoropolymer, preferably in an amount of at least 30% by weight, or an inorganic substance with a low coefficient of friction selected from the group comprising boron nitride, tungsten sulphide, molybdenum sulphide, silicon carbide, and tungsten carbide, preferably in an amount of at least 30% by weight.

More advantageously, the kitchen utensil according to the invention does not comprise perfluorooctanoic acid (PFOA) and/or per- and polyfluoroalkyl substances (PFAS).

Other embodiments of the utensil are available in the set of claims.

### BRIEF DESCRIPTION OF THE DRAWINGS

FIG. 1 shows the application of various aqueous compositions comprising PEEK to surfaces.

### DETAILED DESCRIPTION OF THE INVENTION

The composition according to the invention uses water-insoluble thermoplastic polymers.

Those skilled in the art know that the polyaryletherketone family of polymers is a water-insoluble thermoplastic.

In the context of this invention, the water-insoluble thermoplastic polymer is advantageously chosen from the group comprising polyaryletherketone, such as polyetherketone (PEK), polyetheretherketone (PEEK) or polyetherketoneketone (PEKK), polysulfone, polyethersulfone, polyetherimides, polyamide, polyimide, aramid, polyphenylene oxide (PPO), compounds comprising phenoxy groups, modified polyphenylene oxide (modified PPO), polyvinylpyrrolidone (PVP), poly(aryl)sulphide, polystyrene (PS), polycarbonate, polyarylether, polyaryletherketone, polyarylsulphide, polybenzimidazole, polyvinylidene fluoride (PVDF), ethylene tetrafluoroethylene (ETFE), perfluoroalkoxy, fluorinated ethylene-propylene (FEP), polychlorotrifluoroethylene (E-CTFE), ethylene vinyl alcohol (EVOH), and mixtures thereof.

Advantageously, the thermoplastic polymer is PEEK or a polyamide or polyimide.

Even more advantageously, the thermoplastic polymer can be combined with EVOH; a preferred combination is a polyamide (or polyimide) with EVOH.

Therefore, the inventors discovered that these thermoplastic polymers could be stably formulated in the presence of a mineral dispersant having a layered structure, for example, graphene oxide or boron nitride, optionally functionalised.

Therefore, a first aspect of this invention relates to an aqueous composition comprising:
a water-insoluble thermoplastic polymer or a polyaryletherketone,
an inorganic thickening and/or stabilising agent derived from a silicate, and
a mineral dispersant having a layered structure or graphene oxide or boron nitride, optionally functionalised.

The inventors noted, with surprise, that the mineral dispersant (for example, graphene oxide or boron nitride) makes it possible to stabilise an aqueous composition of a water-insoluble thermoplastic polymer or a polyaryletherketone, such as PAEK, polyamide, or polyimide. The inventors believe that, in the formulation they have developed, graphene oxide (or boron nitride) acts advantageously as a dispersing agent.

According to a preferred embodiment, the inorganic thickening and/or stabilising agent derived from a silicate may have a layered structure and may be selected for specific applications.

Furthermore, the mineral dispersant having a layered structure may, for example, be graphene oxide, boron nitride, or any other functional equivalent known to those skilled in the art.

Furthermore, and advantageously, the graphene oxide or boron nitride may be provided in multilayers, which allows for several layers, preferably at least two layers parallel to each other, more preferably at least five layers, and even more preferably at least ten layers. This also extends to any other mineral dispersant having a layered structure.

Advantageously, the mineral dispersant with a layered structure is graphene oxide (single- or multi-layer) or boron nitride (single- or multi-layer).

Advantageously, a combination of graphene oxide and boron nitride is also possible.

According to a particularly preferred embodiment of the invention, it is possible to functionalise the mineral dispersant by adding functional groups.

When the dispersant (e.g., boron nitride) is functionalised, it may or may not necessarily be in the form of a layer. Preferably, the functionalised boron nitride will be in the form of a layer.

The inorganic thickener and/or stabiliser derived from a silicate provides a slight stabilising effect to the PAEK composition when present without graphene oxide (or boron nitride).

Surprisingly, however, the formulation of the thermoplastic polymer (PAEK, polyamide, or polyimide) in the presence of both the mineral dispersant (preferably graphene oxide or boron nitride) and the inorganic thickener and/or stabiliser derived from a silicate offers very good stability and facilitates the application of the composition, even on vertical surfaces.

This can also be applied to other mineral thickeners and/or stabilisers in layered form (besides phyllosilicates).

Preferably, the inorganic thickener and/or stabiliser derived from a silicate is talc or an aluminosilicate, preferably a phyllosilicate, preferably chosen from the smectite group (e.g., hectorite or laponite). In the context of this invention, bentonite is advantageously considered a smectite.

Alternatively, or additionally, the inorganic thickening and/or stabilising agent (e.g., aluminosilicate, phyllosilicate, smectite) is a potassium and/or sodium silicate, that is to say that at least 10%, preferably at least 20%, or even at least 40% (by mole) of the alkali or alkaline-earth cations in a molecule of the inorganic thickener and/or stabiliser being a silicate is potassium or sodium.

The inventors have noted that these cations improve the stabilisation of the composition.

Advantageously, the inorganic thickener and/or stabiliser has a layered structure, for example, rectangular or in the form of a flat disc (e.g., laponite).

Preferably, the inorganic thickener and/or stabiliser is a mineral whose layer thickness is less than 10 nm, preferably less than 5 nm, or even between approximately 0.2 nm and 1 nm.

The inventors have noted that this type of structure exhibits synergy with the mineral dispersant, preferably graphene oxide or boron nitride.

For the layered structures of the organic thickener and/or stabiliser, the dimensions of the largest surface area preferably vary between 25 and 300 nm. The layer preferably has a rectangular (largest) surface area, for example, with a length between 200 and 400 (or 300) nm, for example approximately 250 nm, and a width between 30 and 75 nm, preferably approximately 50 nm. For example, the layer has a (largest) substantially square surface, for example with a side size of between 200 and 400 nm, for example about 300 nm. Alternatively, the layer has a disc-shaped surface, the diameter of which is advantageously between 10 and 50 nm, for example about 25 nm.

In the context of this invention, the thickening and/or stabilising agent may relate to the same compound that has both a thickening and stabilising effect

In other words, the ratio between the largest surface area and the thickness of the thickener and/or stabiliser is preferably greater than 100, preferably greater than 1000.

The inventors have noted that incorporating the thickener and/or stabiliser (silicate, aluminosilicate) at a content of between 0.1 and 5% (by weight), preferably between 0.5 and 2%, such as approximately 0.8% or approximately 1% by weight (weight of silicate: total weight of the aqueous composition) works well.

In other words, an advantageous weight ratio between the water-insoluble thermoplastic polymer, such as a PAEK (PEK, PEEK, PEKK) or a polyamide or polyimide and the thickener and/or stabiliser (silicate, aluminosilicate) is between 10 and 100, preferably between 20 and 75, such as between 40 and 50 (weight of PAEK: weight of thickener and/or stabiliser).

In the context of this invention, graphene oxide (CAS 1034343-98-0) preferably means a two-dimensional layered structure (i.e., single- or multi-layer layered(s)) composed of carbon atoms arranged in a hexagonal shape and substituted by —OH, carbonyl, epoxy and carboxyl residues. Advantageously, the graphene oxide of this invention consists of a superposition of layers, preferably parallel to each other, of fewer than 20, preferably fewer than 15, and more preferably fewer than 10 layers. The graphene oxide may comprise 1, 2, 3, 4, 5, 6, or 7 layers (sheets), as well as mixtures of these structures. This also advantageously applies to boron nitride or any other mineral dispersant that has a layered structure.

Graphene oxide can be obtained by treating graphite with a strong oxidant, followed by separation into layers in an alkaline solution.

Those skilled in the art are familiar with methods for producing layered boron nitride. In the context of this invention, the boron nitride will preferably always be in layered form (single- or multi-layer).

The inventors have noticed that an addition of graphene oxide in a weight content of between 0.1% and 2% by weight, preferably between 0.2 and 1%, for example about 0.4%, works well (weight of graphene oxide: weight of the aqueous composition). This applies to the mineral dispersant as defined in this invention.

In other words, an advantageous weight ratio between the water-insoluble thermoplastic polymer, such as PAEK (PEK, PEEK, PEKK) and the mineral dispersant (preferably graphene oxide or boron nitride) is between 20 and 500, preferably between 50 and 200, such as between 100 and 150 (weight of PAEK: weight of graphene oxide).

Alternatively, the addition of boron nitride as a mineral dispersant is done in an amount of up to 5% by weight.

When boron nitride is used as an additive, it may be present in an amount of at least 5% by weight.

In other words, an advantageous weight ratio between the water-insoluble thermoplastic polymer, such as PAEK (PEK, PEEK, PEKK) and graphene oxide is between 2 and 500, preferably between 5 and 200, such as between 10 and 150 (weight of PAEK: weight of graphene oxide).

Advantageously, the aqueous composition is a dispersion (stabilised by the mineral dispersant (graphene oxide or boron nitride) and the silicate).

In the context of this invention, PAEK is preferably a polymer consisting (substantially) of the units of formula (—Ar-X—) as well as the units of formula (-Ar′-Y—), in which:
Ar and Ar′ each denote a divalent aromatic radical;
Ar and Ar′ are preferably chosen from 1,3-phenylene, 1,4-phenylene, 4,4′-biphenylene, 1,4-naphthylene, 1,5-naphthylene and 2,6-naphthylene, optionally substituted;
X denotes an electron-withdrawing group, which may preferably be chosen from the carbonyl group (more preferred) and the sulfonyl group;
Y denotes a group chosen from an oxygen atom (more preferred), a sulfur atom, an alkylene group, such as in particular —CH2- and isopropylidene.

Among the X units, at least 50 mol. %, preferably at least 70 mol. % and more particularly at least 80 mol. % of the X units represent a carbonyl group. Advantageously, all the X units denote a carbonyl group.

Among the Y units, preferably, at least 50 mol %, preferably at least 70 mol %, and more particularly at least 80 mol % of the Y units represent an oxygen atom. Advantageously, all the Y units denote an oxygen atom.

Preferably, the PAEK is a polyetheretherketone (PEEK), comprising a succession of repeating units of the -(Ar-O-Ar2-O-Ar3-CO)n- type, each Ar, Ar2, and Ar3 independently representing a divalent aromatic radical, preferably a phenylene.

The bonds on either side of each Ar, Ar2, and Ar3 unit (e.g., the groups forming the —O— or —CO— chain) may be of the para, meta, or ortho type (preferably of the para type).

Alternatively, PAEK is a polyetherketoneketone (PEKK), comprising a succession of repeating units of the type -(Ar-O-Ar2-CO-Ar3-CO)n-, each Ar, Ar2 and Ar3 independently representing a divalent aromatic radical, preferably a phenylene.

Preferably, this PAEK consists substantially of the monomers according to formulas (i), (ii), (iii), (iiii) and (v) below.

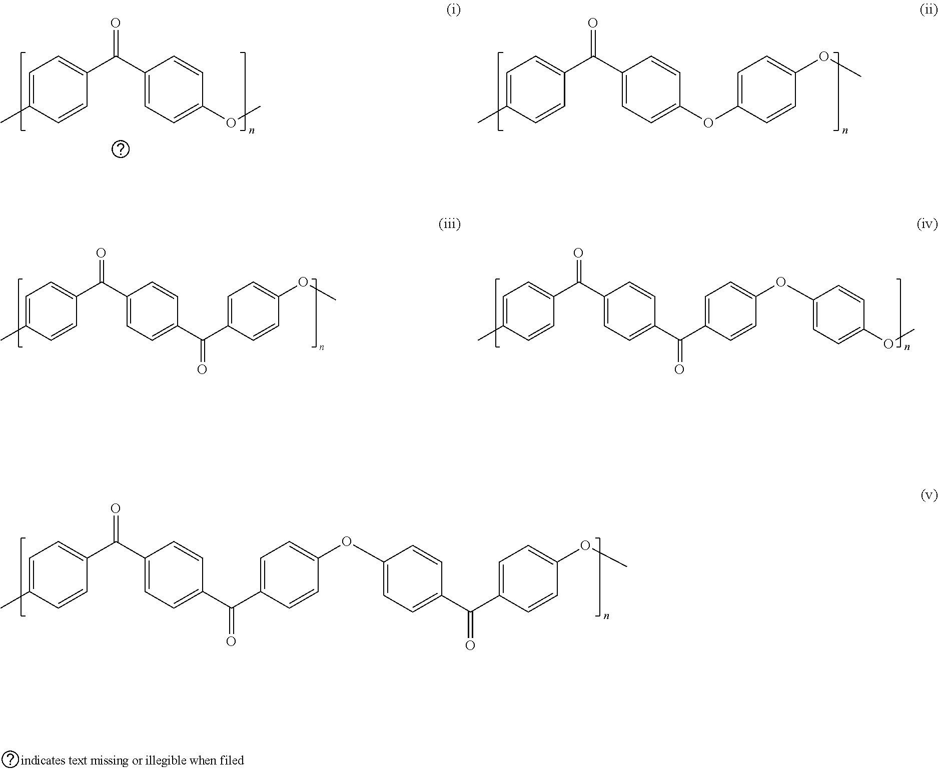

Advantageously, the PAEK of the aqueous composition consists substantially of the monomer of formula (I), the monomer of formula (ii), the monomer of formula (iii), the monomer of formula (iiii) or the monomer of formula (v), the PAEK of the aqueous composition preferably consists substantially of the monomer of formula (ii), polyetheretherketone (PEEK). According to a preferred alternative, the PAEK of the aqueous composition consists substantially of the monomer of formula (iii), polyetherketoneketone (PEKK); PEEK (CAS no. 29658-26-2 being more preferable than PEKK.

Preferably, in the context of this invention, in addition to PAEK, the water-insoluble thermoplastic polymer is chosen from the group comprising polyaryletherketone, such as polyetherketone (PEK), polyetheretherketone (PEEK) or polyetherketoneketone (PEKK), polysulfone, polyethersulfone, polyetherimides, polyamide, polyimide, aramid, polyphenylene oxide (PPO), compounds comprising phenoxy groups, modified polyphenylene oxide (modified PPO), polyvinylpyrrolidone (PVP), poly(aryl)sulphide, polystyrene (PS), polycarbonate, polyarylether, polyaryletherketone, polyarylsulphide, polybenzimidazole, polyvinylidene fluoride (PVDF), ethylene tetrafluoroethylene (ETFE), perfluoroalkoxy, fluorinated ethylene-propylene (FEP), polychlorotrifluoroethylene (E-CTFE), ethylene vinyl alcohol (EVOH), and mixtures thereof.

Preferably, the water-insoluble thermoplastic polymer, such as PAEK (e.g., PEK, PEEK, or PEKK), is inserted in the form of particles, preferably substantially spherical particles.

Advantageously, these particles have a known size, which is not too large.

In the context of this invention, d50 preferably means that 50% of the particles have a size smaller than the value indicated below.

In the context of this invention, d90 preferably means that 90% of the particles have a size smaller than the value indicated below.

In the context of this invention, d99 preferably means that 99% of the particles have a size smaller than the value indicated below.

The preferred d50 value for the water-insoluble thermoplastic polymer, such as PAEK (PEEK) of this invention is 50 μm, preferably 40 μm, preferably 30 μm, preferably 20 μm, or even 10 μm or 5 μm.

Alternatively, or in addition, the preferred d90 value is 60 μm, preferably 50 μm, preferably 40 μm, preferably 25 μm, or even 15 μm or 10 μm.

Alternatively, or in addition, the preferred d99 value is 80 μm, preferably 70 μm, preferably 60 μm, preferably 50 μm, or even 20 μm.

In the context of this invention, when the water-insoluble thermoplastic polymer particle, such as PAEK, is not spherical, the diameter is preferably the equivalent diameter, such as the volume equivalent diameter dv (V=π/6·dv³).

Preferably, the aqueous composition (dispersion) comprises at least 30% by weight of water.

Preferably, the aqueous composition (dispersion) comprises at least 30% by weight of water-insoluble thermoplastic polymer, such as PAEK (PEK, PEEK, PEKK), for example between 40 and 50% by weight, such as approximately 45% by weight.

Alternatively, the aqueous composition further comprises a fluoropolymer or nylon fibres, to the (partial) detriment of the PAEK (PEK, PEEK, PEKK). Such a composition comprises between 10 and 30% by weight of PAEK (such as PEEK) and between 10 and 30% by weight of fluoropolymer or nylon microbeads.

According to another preferred alternative, the aqueous composition further comprises an additive, chosen from the group comprising tungsten sulphide (WS2), molybdenum sulphide (MoS2), boron nitride, tungsten carbide, silicon carbide, inorganic oxides (titanium oxide, silicon oxide, zirconium oxide), and mixtures thereof.

The addition of fluoropolymer, boron nitride (also listed as a dispersant), tungsten sulphide, or molybdenum sulphide provides good non-stick properties to a coating produced from this aqueous composition, for example, the coating of a kitchen utensil, such as a kitchen utensil intended for cooking; the incorporation of PAEK (PEEK) provides chemical, thermal, and mechanical resistance, and the fluoropolymer or the additives listed above provide the non-stick properties.

Furthermore, metal carbides or oxides are advantageously included to increase mechanical strength, for example, abrasion or scratch resistance, for example, when the thermoplastic polymer is not a PAEK.

The additives are advantageously incorporated at a weight content of at least 5%, preferably between 5 and 20%, more preferably between 10 and 15%.

Preferably, the fluoropolymer or additive is incorporated, during the process described below, in powder or emulsion form.

In the context of this invention, the fluoropolymer referenced in this application may be replaced, if desired, by an inorganic substance with a low coefficient of friction chosen from the group comprising boron nitride, tungsten sulphide, molybdenum sulphide, silicon carbide, and tungsten carbide, preferably in an amount of at least 30% by mass. This applies to each paragraph that provides for the addition of fluoropolymer.

Preferably, this fluoropolymer (or the composition comprising this fluoropolymer) is free from toxic or potentially toxic compounds, such as perfluorooctanoic acid (PFOA) and/or per- and polyfluoroalkyl substances (PFAS). Advantageously, this fluoropolymer is compatible with culinary (food) applications. A preferred fluoropolymer is polytetrafluoroethylene (PTFE), preferably free from PFOA and/or per- and polyfluoroalkyl substances (PFAS).

Therefore, the above additives (not being a fluoropolymer) are advantageous because they allow for complete freedom from fluoropolymers when necessary.

The incorporation of nylon microbeads reduces costs, but this somewhat reduces mechanical strength and thermal stability.

A related aspect of this invention relates to a method for formulating this composition, comprising the steps of:
1—Subjecting the demineralised water to mechanical stirring
2—Adding the silicate or a silicate derivative (clay) in small portions and under vigorous mechanical stirring (2000-5000 rpm), advantageously so as to obtain layered clay (if the incorporated silicate is clay)
3—Adding the mineral dispersant (graphene oxide and/or boron nitride, for example)
4—Adding the water-insoluble thermoplastic polymer powder such as PAEK (PEEK)
5—Optionally, adding the second polymer or additive (chosen from tungsten sulphide, molybdenum sulphide, tungsten carbide, silicon carbide, inorganic oxides, and mixtures thereof).
6—Leave stirring for 1 to 2 hours to thoroughly disperse the water-insoluble thermoplastic polymer powder, such as PAEK (PEK, PEEK, PEKK), advantageously until a fluid liquid is obtained. Preferably, the decrease in viscosity of the composition is monitored over time.

A related aspect of this invention concerns a method for applying this composition, which comprises the step of spraying this composition described above onto a substrate and then curing the coated substrate.

A preferred substrate for this method is a metal or ceramic. Advantageously, the metal is nickel, iron, aluminium, cobalt, and alloys thereof.

Therefore, preferably, the substrate is a metal, and this method advantageously comprises the preliminary step of adding a primer layer consisting substantially of (i) an aluminium oxide (hereinafter sometimes referred to as “first particle”), (ii) boron nitride (or beryllium oxide or aluminium nitride; hereinafter sometimes referred to as “second particle”) and (iii) aluminium (tri)phosphate (before spraying the composition described above onto this primer layer), this primer layer being advantageously cured onto the substrate, for example before applying the composition comprising PAEK (PEEK).

A preferred temperature for curing the primer layer is approximately 370° C.

A preferred temperature for curing the composition comprising PAEK (preferably PEEK) is approximately 420° C. (e.g., between 350° C. and 450° C.). A preferred duration is between 5 and 30 minutes, for example, approximately 10 minutes.

In particular, Al₂O₃ particles (e.g., with a diameter between 1 and 10 μm, preferably 3 to 5 μm), BN particles (e.g., with a diameter between 1 and 20 μm), and aluminium phosphate Al(H₂PO₄)₃ are suspended in water with stirring, then sprayed onto the metal layer before curing (e.g., involving a step at 95° C. and/or 370° C.). The inventors have achieved good results with Al2O3:BN mass ratios of between 1:20 and 1:5, preferably between 1:10 and 1:6.

The preferred BN is hexagonal in structure.

Another related aspect of this invention concerns a substrate chosen from a metal and a ceramic, coated with a coating comprising this water-insoluble thermoplastic polymer, such as PAEK (e.g., PEEK); this coating further comprises a graphene oxide (or boron nitride) and a silicate and may further comprise one of the additives listed above, if included.

Preferably, the coating of this substrate has a thickness of between 5 and 200 μm, advantageously between 20 and 150 μm, such as between 50 and 120 μm, or between 70 and 100 μm.

Advantageously, this coating comprises at least 30% by weight of water-insoluble thermoplastic polymer, such as PAEK (e.g., PEEK) and/or at least 0.5% of a silicate derivative (typically approximately 1%) and/or at least 0.3% of a graphene oxide or boron nitride.

Alternatively, preferably, the coating of this substrate comprises at least 10% by weight of PAEK (e.g., PEEK) and at least 10% by weight of nylon microbeads.

Preferably, the coating of this substrate does not comprise chromium (VI) and/or fluoropolymers, such as perfluorooctanoic acid (PFOA) and/or per- and polyfluoroalkyl substances (PFAS).

Another related aspect of this invention concerns a kitchen utensil comprising a coating comprising a PAEK (e.g., PEEK), a silicate derivative, and a graphene oxide, and preferably a non-stick fluoropolymer, advantageously polytetrafluoroethylene (PTFE), or at least 5% by weight of an additive having a coefficient of friction of less than 0.3, preferably less than 0.2, more preferably less than 0.1, preferably chosen from the group comprising tungsten sulphide, molybdenum sulphide, boron nitride, tungsten carbide, silicon carbide, inorganic oxides (titanium oxide, silicon oxide, zirconium oxide), and mixtures thereof.

Preferably, the additive is not a fluoropolymer. This kitchen utensil coating preferably does not include perfluorooctanoic acid (PFOA) and/or per- and polyfluoroalkyl substances (PFAS).

Another related aspect of this invention relates to a metal surface coated with a (ceramic) primer layer consisting substantially
of aluminium oxide particles,
of second particles selected from boron nitride, beryllium oxide, or aluminium nitride, and
of a binder (preferably an aluminium phosphate),
   and a surface layer comprising a polyaryletherketone, a silicate derivative (preferably an aluminosilicate and/or a sodium or potassium silicate), and a graphene oxide, this polyaryletherketone being present in the surface layer in an amount of at least 30% by mass.

Preferably, in this primer layer, the mass ratio between the aluminium oxide and the second particles chosen from boron nitride, beryllium oxide, or aluminium nitride (Al2O3:BN or Al2O3:BeO or Al2O3:AlN) is between 1:20 and 1:5, preferably between 1:10 and 1:6.

This provides good thermal conductivity while retaining sufficient mechanical strength.

The preferred second particle is boron nitride, preferably hexagonal boron nitride.

This provides maximum thermal conductivity.

The preferred binder for this primer layer is aluminium triphosphate. Preferably, the primer layer comprises between 20 and 50% by weight of the binder (aluminium triphosphate), preferably between 30 and 40% by weight of the binder.

This ensures good particle cohesion and good mechanical strength, as well as good thermal conductivity.

In the context of this invention, the polyaryletherketone of the surface layer is preferably as described above for the aqueous composition; the preferred polyaryletherketone is polyetheretherketone (PEEK) or polyetherketoneketone (PEKK).

In the context of this invention, the expression “water-insoluble” means that the thermoplastic polymer has a water solubility of less than 100 mg/L of water at room temperature (20° C.).

Preferably, the thermoplastic polymer of the invention is semi-crystalline with a crystallinity level of between 10 and 90%, preferably between 20 and 80%, measured by DSC.

The coefficient of friction used in the context of this invention is measured using the horizontal plane method with equipment compliant with ISO 8295 (plastic, sheet, and film). Overall, the measuring device (Thwing-Albert FP-2260 Friction/Peel Tester) substantially comprises a horizontal test table, a sled, and a traction mechanism capable of producing relative movement between the sled and the test table, regardless of which of the two constitutes the moving part.

The coatings to be tested are placed in plane contact and under uniform contact pressure. The contact pressure force should be produced by a sled whose square-shaped contact base has an area of 40 cm* (edge length: 63 mm). The total mass of the sled should be 200 g (exerting a pressure force equal to 1.96 N). The force required to move the surfaces relative to each other is recorded. This force, recorded during sliding, allows the coefficient of friction to be calculated.

Other characteristics and advantages of this invention will be drawn from the following non-limiting description, with reference to the drawings and examples.

### EXAMPLES

It is understood that this invention is in no way limited to the embodiments described above and that many modifications may be made thereto without departing from the scope of the appended claims.

### Example 1

### Composition of the PEEK-Based Dispersion:

PEEK powder: 45%
Smectite group clay: 1%
Graphene oxide 1.5% (as a 25 wt % paste in water)
Demineralised water: 52.5

### Preparing the Dispersion:

1—Subject the demineralised water to mechanical stirring
2—Add the clay in small portions during vigorous mechanical stirring (2000-5000 rpm)
3—Add the graphene oxide (as a 25 wt % paste in water)
4—Add PEEK powder
5—Leave stirring for 1 to 2 hours to thoroughly disperse the PEEK powder (to obtain a fluid liquid)

### Example 2

### Composition of the PEEK-Based Dispersion:

PEEK powder: 45%
Graphene oxide 1.5% (as a 25 wt % paste in water)
Demineralised water: 53.5

### Preparing the Dispersion:

1—Subject the demineralised water to mechanical stirring
2—Add graphene oxide during vigorous mechanical stirring (2000-5000 rpm)
3—Add PEEK powder
4—Leave stirring for 1 to 2 hours to thoroughly disperse the PEEK powder (to obtain a fluid liquid)

### Example 3

### Composition of the PEEK-Based Dispersion:

PEEK powder: 45%
Smectite group clay: 1%
Demineralised water: 54%

### Preparing the Dispersion:

1—Subject the demineralised water to mechanical stirring
2—Add the clay in small portions during vigorous mechanical stirring (2000-5000 rpm)
3—Add PEEK powder
4—Leave stirring for 1 to 2 hours to thoroughly disperse the PEEK powder (to obtain a fluid liquid)

### Dispersion Stability Test:

The three dispersions (examples 1, 2, and 3) were stored in test tubes and left to stand for one month.
Dispersion example 1 is very stable; the PEEK powder remains evenly dispersed.
Dispersion example 2: beginning of sedimentation of the PEEK powder.
Dispersion example 3: Strong sedimentation of the PEEK powder.

### Method of Applying PEEK in a Dispersion:

The 3 different PEEK dispersions are applied by spraying using a pneumatic gun (nozzle: 1 to 1.5 mm).

### Substrate Preparation:

The surface of the metal substrates is prepared by sandblasting (obtaining a surface roughness Ra of 2 to 4 microns).

### Application Conditions:

Gun: 1 mm nozzle
Air pressure: 2 to 4 bar

The metal substrates are placed vertically to measure the effect of dispersion flow on the application.
Wet applied thickness: 100 to 200 microns
Dry applied thickness: 50 to 100 microns.

### Curing Conditions:

Curing at 420° C. for 10 minutes

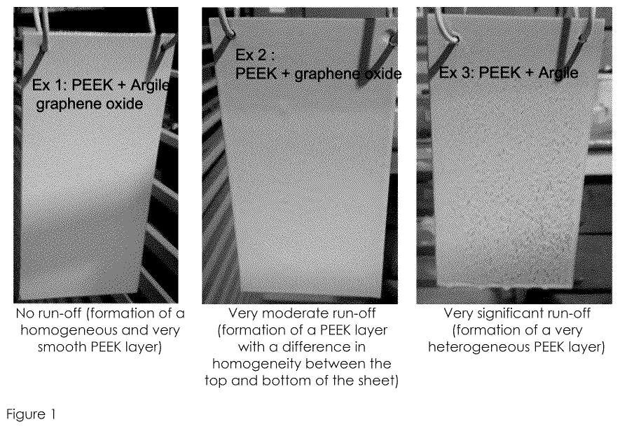

FIG. 1 shows that the composition of Example 1 is by far the best. The composition of Example 2, which appeared quite good after the sedimentation test, does not allow for even application.

### Example 4: PEEK+Fluoropolymer

### Composition of the PEEK-Based Dispersion:

PEEK powder: 22.5%
Fluoropolymer powder (PFA): 22.5%
Smectite group clay: 1%
Graphene oxide 1.5% (as a 25 wt % paste in water)
Demineralised water: 52.5

### Preparing the Dispersion:

1—Subject the demineralised water to mechanical stirring
2—Add the clay in small portions during vigorous mechanical stirring (2000-5000 rpm)
3—Add graphene oxide
4—Add PEEK powder
5—Add fluoropolymer powder
6—Leave stirring for 1 to 2 hours to thoroughly disperse the PEEK powder (obtaining a fluid liquid).

Application and curing are similar to the PEEK-based dispersion (Example 1).

### Measurement of Contact Angle

Ex 1 (PEEK only): contact angle between 3° and 40° (hydrophilic surface and poor anti-stick)
Ex 4 (PEEK+PFA): contact angle between 90 and 1000 (hydrophobic surface and good anti-stick).

### Example 5: PEEK+Inorganic Anti-Stick Additives

### Composition of the PEEK-Based Dispersion:

PEEK powder: 25 to 35%
Additive powder 1 (WS2 particles with a D50 between 0.5 and 8 microns): 1 to 5%
Additive powder 2 (BN particles with a D50 between 0.5 and 8 microns): 1 to 5%
Additive powder 3 (SiC particles with a D50 between 0.5 and 8 microns): 1 to 5%
Smectite group clay: 0.5 to 1%
Graphene oxide 0.1 to 1% (as a 25 wt % paste in water)
Demineralised water: 60 to 70%

### Preparing the Dispersion:

1—Subject the demineralised water to mechanical stirring
2—Add the clay in small portions during vigorous mechanical stirring (2000-5000 rpm)
3—Add graphene oxide
4—Add PEEK powder
5—Add additives 1, 2, and 3 powder
6—Leave stirring for 1 to 2 hours to thoroughly disperse the PEEK powder+additives (a fluid liquid is obtained).

Application and curing are similar to the PEEK-based dispersion (Example 1).

### Contact Angle and Anti-Stick Measurement

Ex 5 (PEEK+additives 1, 2, and 3): contact angle between 90 and 1000 (hydrophobic surface and good anti-stick).

### Example 6: Polyamide 11 (Powder with D50 Between 10 and 50 Microns)

### Composition of the Polyamide 11-Based Dispersion:

Polyamide 11 powder: 35 to 45%
Smectite group clay: 0.5 to 1%
Graphene oxide 0.1 to 1% (as a 25 wt % paste in water)
Demineralised water: 55 to 67%

### Preparing the Dispersion:

1—Subject the demineralised water to mechanical stirring
2—Add the clay in small portions during vigorous mechanical stirring (2000-5000 rpm)
3—Add graphene oxide
4—Add polyamide 11 powder
5—Leave stirring for 1 to 2 hours to thoroughly disperse the polyamide 11 powder (to obtain a fluid liquid).

Similar application to the PEEK-based dispersion (Example 1).

### Curing Conditions:

Curing at 250° C. for 10 minutes

### Example 7: Polyimide (Powder with D50 Between 10 and 50 Microns, Tg=245° C. and Tm=388° C.)

### Composition of the Polyimide-Based Dispersion:

Polyimide 11 powder: 35 to 45%
Smectite group clay: 0.5 to 1%
Graphene oxide 0.1 to 1% (as a 25 wt % paste in water)
Demineralised water: 55 to 67%

### Preparing the Dispersion:

1—Subject the demineralised water to mechanical stirring
2—Add the clay in small portions during vigorous mechanical stirring (2000-5000 rpm)
3—Add graphene oxide
4—Add polyimide powder
5—Leave stirring for 1 to 2 hours to thoroughly disperse the polyimide powder (obtaining a fluid liquid).

Similar application to the PEEK-based dispersion (Example 1).

### Curing Conditions:

Curing at 440° C. for 10 minutes

1. An aqueous composition comprising:
a water-insoluble thermoplastic polymer or a polyaryletherketone,
an inorganic thickening and/or stabilising agent derived from a silicate, and
a mineral dispersant having a layered structure or graphene oxide or boron nitride, optionally functionalised.

2. An aqueous composition according to claim 1, wherein the inorganic thickening and/or stabilising agent derived from a silicate is talc or clay or an aluminosilicate, preferably a phyllosilicate, more preferably a smectite.

3. An aqueous composition according to claim 1, wherein the thermoplastic polymer is chosen from the group comprising polyaryletherketone, such as polyetherketone (PEK), polyetheretherketone (PEEK) or polyetherketoneketone (PEKK), polysulfone, polyethersulfone, polyetherimides, polyamide, polyimide, aramid, polyphenylene oxide (PPO), compounds comprising phenoxy groups, modified polyphenylene oxide (modified PPO), polyvinylpyrrolidone (PVP), poly(aryl)sulphide, polystyrene (PS), polycarbonate, polyarylether, polyaryletherketone, polyarylsulphide, polybenzimidazole, polyvinylidene fluoride (PVDF), ethylene tetrafluoroethylene (ETFE), perfluoroalkoxy, fluorinated ethylene-propylene (FEP), polychlorotrifluoroethylene (E-CTFE), ethylene vinyl alcohol (EVOH) and mixtures thereof.

4. An aqueous composition according to claim 1, wherein the inorganic thickening and/or stabilising agent derived from a silicate is a potassium and/or sodium silicate.

5. An aqueous composition according to claim 1, wherein the ratio between the maximum surface area and the thickness of the inorganic thickener and/or stabiliser derived from a silicate is greater than 100.

6. An aqueous composition according to claim 1 being a dispersion.

7. An aqueous composition according to claim 1 comprising at least 10%, preferably at least 30% by weight of the water-insoluble thermoplastic polymer, relative to the total weight of the composition, preferably polyaryletherketone, preferably polyaryletherketone consisting substantially of monomers according to formulas (i), (ii), (iii), (iiii) and (v) below 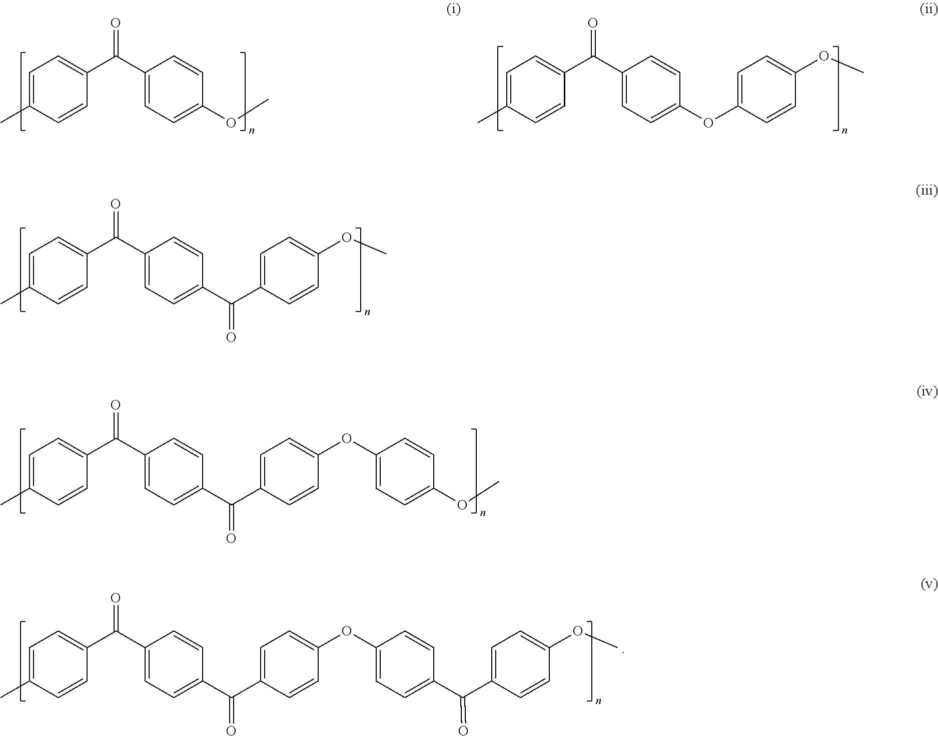
and/or wherein the polyaryletherketone consists substantially of the monomers of formula (ii).

8. An aqueous composition according to claim 1 comprising at least 30% by weight of water relative to the total weight of the composition.

9. An aqueous composition according to claim 1, further comprising at least 10% by mass, preferably at least 30% by mass of a second polymer, preferably chosen from a fluoropolymer, nylon and natural polymers or at least 5% by mass of an additive having a coefficient of friction of less than 0.3, preferably less than 0.2, more preferably less than 0.1 and preferably chosen from the group comprising tungsten sulphide, molybdenum sulphide, boron nitride, tungsten carbide, silicon carbide, inorganic oxides (titanium oxide, silicon oxide, zirconium oxide), and mixtures thereof.

10. A method for formulating an aqueous composition according to claim 1, comprising the steps of adding the following elements to an aqueous solution during mechanical stirring:
an inorganic thickener and/or stabiliser being a silicate or a silicate derivative, then
a mineral dispersant or graphene oxide and/or boron nitride,
particles of a water-insoluble thermoplastic polymer or a polyaryletherketone,
said mechanical stirring preferably being carried out at at least 2000 rpm and/or for at least 1 hour.

11. A method for applying the aqueous composition according to claim 1, comprising the step of spraying, optionally at room temperature, said composition onto a substrate, then curing the coated substrate, so as to fix a coating thereon, preferably for at least 5 minutes and/or at a temperature above the melting temperature of the thermoplastic polymer, preferably between 17° and 450° C., preferably between 40° and 430° C., such as approximately 420° C.

12. The method according to claim 11, wherein the substrate is a metal or a ceramic.

13. A substrate selected from a metal and a ceramic, covered with a coating comprising a water-insoluble thermoplastic polymer or a polyaryletherketone and which can be obtained by the method according to claim 12.

14. A coated substrate according to claim 13, wherein the coating comprises at least 30% by weight of water-insoluble thermoplastic polymer or a polyaryletherketone and/or at least 0.01%, preferably at least 1% of a silicate derivative and/or at least 0.01%, preferably at least 0.1% of a mineral dispersant or graphene oxide and/or boron nitride.

15. A substrate according to claim 14, comprising either at least 60% by weight of the water-insoluble thermoplastic polymer or polyaryletherketone, or at least 30% by weight of the water-insoluble thermoplastic polymer or polyaryletherketone and at least 30% by weight of another polymer, preferably chosen from fluoropolymers, natural fibres and nylon.

16. A kitchen utensil comprising the composition according to claim 1; said kitchen utensil comprising a coating comprising a water-insoluble thermoplastic polymer or polyaryletherketone, a silicate derivative (preferably an aluminosilicate and/or a sodium or potassium silicate) and mineral dispersant or graphene oxide and/or boron nitride, said water-insoluble thermoplastic polymer or said polyaryletherketone being present in the coating in an amount of at least 30% by weight.

17. The kitchen utensil of claim 16, wherein the coating further comprises a fluoropolymer or an inorganic substance with a low coefficient of friction chosen from the group consisting of boron nitride, tungsten sulphide, molybdenum sulphide, silicon carbide, and tungsten carbide, preferably in an amount of at least 30% by weight.

18. The kitchen utensil of claim 17, not comprising perfluorooctanoic acid (PFOA) and/or per- and polyfluoroalkyl substances (PFAS).
